(19) United States
(12) Patent Application Publication
(10) Pub. No.: US 2019/0335758 A1
(43) Pub. Date: Nov. 7, 2019

(54) BIOSTIMULATING COMPOSITION FOR PLANT GROWTH CONTAINING LIPOPEPTIDES

(71) Applicant: LIPOFABRIK, Villeneuve D'Ascq (FR)

(72) Inventors: François COUTTE, Aix (FR); Arnaud DELECROIX, Fleurbaix (FR); Abdelnasser EL GHAZOUANI, Lesquin (FR); Philippe JACQUES, Liege (FR)

(73) Assignee: LIPOFABRIK, Villeneuve D'Ascq (FR)

(21) Appl. No.: 16/473,602

(22) PCT Filed: Dec. 29, 2017
(86) PCT No.: PCT/FR2017/053865

§ 371 Date: Jun. 25, 2019

(30) Foreign Application Priority Data
Dec. 30, 2016 (FR) 16/63540

(51) Int. Cl. A01N 63/02; C05F 11/08; C05G 3/02; A01C 1/06

(52) U.S. Cl. CPC A01N 63/02; A01C 1/06; C05G 3/02; C05F 11/08

(57) ABSTRACT

The present disclosure relates to the field of biostimulants used in agriculture to promote plant growth. In particular, lipopeptides are used as a biostimulant agent for plant growth, a biostimulant composition contains lipopeptides, a method for obtaining such a composition is provided, and a method for promoting an increase in plant matter by applying this composition is disclosed. In another aspect, seeds are coated with a biostimulant composition.

### CROSS-REFERENCE TO RELATED APPLICATIONS

This application is a National Phase entry of International Application No. PCT/FR2017/053865, filed on Dec. 29, 2017 which claims priority to French Application No. 16/63540 filed on Dec. 30, 2016, both of which are incorporated by reference herein.

### TECHNICAL FIELD

This invention relates to the field of biostimulants used in agriculture to promote the growth of plants. In particular, the present invention relates to the use of lipopeptides as a biostimulant agent for the growth of plants as well as a biostimulant composition containing lipopeptides, a method for obtaining such a composition and a method for promoting the gain of plant material by applying this composition. Seeds coated with a biostimulant composition are also part of the invention.

### BACKGROUND

The increase in food demand due to the continuous increase in the world population is a real challenge for the future. Biostimulants can effectively contribute to this challenge and are increasingly being used in global agricultural production. The speed with which a plant roots reach the nutrients is a key parameter in the plant initial development and growth success, usually in the first few weeks. Biostimulants make it possible to improve plant growth by providing natural products-based nutrients on or by helping plants access their nutrients.

Biostimulants promote the growth and development of plants throughout the entire life cycle of the crop, from seed germination to plant maturity, they improve the efficiency of plant metabolism leading to increased harvest and better quality. They increase the plants tolerance to abiotic stresses and their ability to recover from them. They facilitate the assimilation, passage and use of nutrients. They improve the quality of agricultural production, including sugar content, colour and fruit size. In addition, they regulate and improve the water content of plants. Finally, they increase certain physico-chemical properties of the soil and promote the development of microorganisms in the field.

Using microorganisms or microorganism cocktails for the bic}-stimulation of plants is well known. These methods are based on the application of compositions containing a purified microorganism or a mixture of microorganisms, such compositions containing strains of Bacillus in particular.

The plant growth biostimulant compositions described in the literature contain purified Bacillus strains, alone or in combination with other components. For example, application WO2016/109332 describes compositions containing a biologically pure culture of Bacillus sp. strain D747 (filed as FERM BP-8234). Application WO2016/108976 describes compositions containing a biologically pure culture of the Bacillus pumilus rti strain279 (filed after the ATCC under number PTA-121164) that can be applied alone or in combination with chemicals or other microbial agents, or both, to promote plant growth and provide protection and/or control against plant diseases.

However, there are disadvantages to such compositions. For the composition to be active, it is desirable for the microorganism to be alive and able to multiply on the plant; however, these conditions are difficult to control. In addition, in an agricultural context in which ecological solutions are promoted, using genetically modified strains of microorganisms is problematic.

### SUMMARY

The present invention provides a solution to this issue. Indeed, the inventors have surprisingly shown that a composition containing lipopeptides can be used to stimulate the growth of plants. A preparation based on lipopeptides or on Bacillus culture supernatant containing lipopeptides and not containing the Bacillus strain(s) producing this supernatant has the double advantage of being active itself without requiring in situ production of biostimulant molecules and being GMO-free. None of the prior art documents describe the use of such a preparation containing lipopeptides for stimulating plant growth. Thus, the present invention proposes an innovative approach to the biostimulation of plant growth.

A first object of the invention relates to the use of at least one lipopeptide as a biostimulant for plant growth. Indeed, the inventors have, for the first time, demonstrated the biostimulating effect of lipopeptides on plant growth by showing the stimulating effect of a preparation of purified lipopeptides. Thus, they propose to use lipopeptides as a biostimulant agent. The biostimulant agent may be a composition obtained from a supernatant of at least one strain of Bacillus sp, a composition concentrated in lipopeptides or a composition comprising purified lipopeptides.

Thus, a second object of the invention relates to a composition that biostimulates plant growth, characterized in that this composition includes at least one lipopeptide. Lipopeptides may be purified, concentrated or contained in a supernatant of a Bacillus sp. culture to the exclusion of producing cells. In a preferred embodiment, the biostimulant composition corresponds to a composition concentrated in lipopeptides or a composition comprising purified lipopeptides.

As used here, the term “supernatant” refers to the supernatant or supernatant extract of at least one strain of Bacillus sp. As used here, the term “lipopeptide concentrated composition” refers to a solution or composition obtained by concentrating a culture supernatant of at least one strain of Bacillus sp. As used here, the term “composition comprising purified lipopeptides” refers to a solution or composition obtained by purifying lipopeptides from a solution containing lipopeptides such as a culture supernatant of at least one strain of Bacillus sp. or a concentrated lipopeptide composition. In these different compositions, the nature and quantity and purity of lipopeptides may vary.

As defined here, a “biostimulant composition” is a composition (or solution or preparation) that can improve plant growth. The applicable growth evaluation criteria are multiple; some criteria are described in the experimental part. This involves, for example, assessing the gain as regards the germination time, root size, biomass or plant height attributable to the application of the biostimulant composition. In order to verify whether such a preparation has biostimulating properties, said supernatant may be applied to the upper parts of the plant by watering and/or at the root level by watering and/or soaking or by coating/dipping the seeds.

Bacillus sp. strains are known for their ability to produce lipopeptides. The Bacillus strains that may be used in this invention are natural or genetically modified strains. In a particular embodiment, the strains of Bacillus sp. are selected from Bacillus subtilis, Bacillus amyloliquefaciens, Bacillus licheniformis, Paenibacillus polymixa, Bacillus pumilus, Bacillus thuringiensis, Bacillus sphaericus, Bacillus coagulans, Bacillus mycoides, Bacillus velenzensis and Bacillus firmus, Bacillus methylotrophicus, Bacillus megaterium, Bacillus vallismortis.

Advantageously, Bacillus strains are chosen from Bacillus subtilis and Bacillus amyloliquefaciens (recently recognized as Bacillus velenzensis). In a preferred embodiment, B. subtilis strains are selected from ATCC 6633, ATCC 21332, 168, ATCC 9943 and NCIB 3610 and their derivatives; B. amyloliquefaciens strains are selected from FZB42 and LMG S-29032 (also known as GA1) and their derivatives.

In another particular embodiment, the biostimulant composition is obtained by concentrating the supernatant. Thus, the concentrated composition can correspond to a concentration of at least a factor 2, or even a factor 5 or 10 in relation to the harvested supernatant, preferably by at least a factor 20, and even more preferably by at least a factor 50. The biostimulant composition can also be obtained by purifying the lipopeptides contained in the supernatant. Thus, it is possible to propose biostimulant solutions having a determined composition, both qualitatively (nature of the lipopeptides present) and quantitatively.

A biostimulant composition according to the invention can also be defined by its lipopeptide content. Thus, in a preferred embodiment, a lipopeptide preparation according to the invention may contain lipopeptides at a concentration of at least 10 mg/L (0.001%), 20 mg/L, 50 mg/L, 100 mg/L (0.01%), 200 mg/L, 500 mg/L, 1 g/L (0.1%), 2 g/L, 5 g/L (0.5%), 10 g/L (1%), 20 g/L, 50 g/L preferably between 1% and 7%, in particular 1%, 2%, 3%, 4%, 5%, 6% or 7%, and even more preferably by at least 10%, or at least 20%, knowing that a 1% solution corresponds to a concentration of 10 g/L.

A composition concentrated in lipopeptides or a composition comprising purified lipopeptides may contain between 0.002% and 15% lipopeptides, the purity of which may vary. In particular, such compositions may have a lipopeptide purity greater than or equal to 10%, preferably greater than or equal to 15%, 20%, 30% , 40% or 50%. In a particularly preferred embodiment, these compositions have a lipopeptide purity greater than or equal to 60%, preferably greater than or equal to 70%, 75%, 80%, 85%, 90%, 95%, 99% or even 100%.

Among lipopeptides with biostimulating properties for plant growth, lipopeptides of the iturin, surfactins, fengycins, kurstakins and locillomycins families are particularly interesting in the context of this invention. In a preferred embodiment, the biostimulant composition is defined by its content of molecules belonging to the iturin family and/or molecules belonging to the surfactin family and/or molecules belonging to the fengycin family and/or molecules belonging to the kurstakin family and/or molecules belonging to the locillomycin family (see Table in FIG. 1).

“Molecules of the iturin family” means iturin A, mojavensin, mycosubtilin, and bacillomycins A, B, C, D, F and L. “Molecules of the surfactant family” means surfactins A, B, C, lichenysin and pumilacidin. “Molecules of the fengycin family” means fengycins A and B, plipastatins A and B and agrastatin. Thus, for example, a biostimulating composition, according to the invention, may contain between 0.002 and 25% lipopeptides, in particular between 1 and 15% lipopeptides.

In a first embodiment, this composition includes between 0.002 and 25% lipopeptides in the following proportions: molecules belonging to the 10-90% iturin family, molecules belonging to the 10-90% surfactin family, molecules belonging to the 0-50% fengycin family. In a second embodiment, this composition comprises between 0.002 and 25% lipopeptides in the following proportions: molecules belonging to the 0-100% iturin family, molecules belonging to the 0-100% surfactin family, molecules belonging to the 0-100% fengycin family.

Another biostimulating composition according to the invention may contain between 0.002 and 25% lipopeptides, preferably between 1 and 15% lipopeptides, in the following proportions:
100% surfactin
100% fengycin
100% iturin, especially mycosubtilin
a mixture of iturin and surfactin
a mixture of mycosubtilin and surfactin
a mixture of iturin and fengycin
a mixture of mycosubtilin and fengycin
a mixture of surfactin and fengycin
a mixture of iturin, including mycosubtilin, surfactin and fengycin.
   A composition according to the invention may also contain primary metabolites produced by said strain, such as acetoin, 2-3 butanediol, auxin precursors and/or phosphate solubilizing enzymes.

Examples of compositions according to the invention are described in the experimental part. Concentrated lipopeptide compositions are described in Example 2. Compositions obtained by concentration of culture supernatant and comprising either 175 mg/L of iturin, in particular iturin, in particular mycosubtilin, and 75 mg/L of surfactin A, or 700 mg/L of iturin, in particular mycosubtilin, and 300 mg/L of surfactin A, significantly increase the size of the tomato plants and the amount of fresh biomass in the aerial parts of such plants. These two compositions also significantly increase the amount of fresh biomass in the aerial and root parts of the wheat plants. Another composition comprising 350 mg/L of iturin, in particular mycosubtilin, and 150 mg/L of surfactin A significantly increases the amount of fresh biomass of the aerial and root parts of the wheat plants and the chlorophyll content of the aerial parts of these plants.

Compositions of purified lipopeptides according to the invention are described in examples 3 and 4. Compositions comprising purified iturin, including purified mycosubtilin (99%), or purified fengycin (99%) or a mixture of iturin, including mycosubtilin, and surfactin (79%) have a significant effect on root growth, particularly following treatment of tomato seeds (see Example 3). Compositions comprising lipopeptides purified between 30% and 99% in relative proportions of 80% iturin, notably mycosubtilin, and 20% surfactin improve the resistance to water stress, notably of tomato plants. These biostimulant effects of the compositions result in a gain in height of the tomato plants between the beginning and the end of hydric stress, better photosynthetic efficiency and better stomatal conductance (see example 4).

In order to facilitate the penetration of the preparation into the plant, the composition according to the invention may also contain adjuvants. Beneficially, the adjuvant facilitates the penetration of the biostimulant composition into the plant. The choice of adjuvant is guided by the desired effect. For example, wetting agents increase the contact surface between the leaf and the droplet by spreading the biostimulant material and ensure the retention of the product on the cuticle. Oils promote the penetration of biostimulant materials by “breaking” the barrier of the plant epicuticular wax layers; this becomes a disadvantage when it is known that the oil will act in the same way on the cuticles of cultivated plants to the point of weakening its natural defences against pathogenic fungi. Other adjuvants such as penetrants are wetting agents that impregnate the waxy cuticles while respecting their integrity. Salts can also be used as adjuvants, in particular to absorb moisture from the air and thus combat desiccation. Finally, adhesives fix the biostimulant material on the leaves and limit leaching and volatilization. Adjuvants should therefore be adapted to the modes of action of abiostimulant materials (root, contact, systemic or penetrating), to the types of product formulations and to the types of target plants (hairless or hairy leaves, cuticle thickness, plant stages, stomata positions, etc.). Advantageously, the adjuvants are chosen from filled or unfilled polymeric surfactants, alkylpolyglucosides and alkylpolyglucosides esters, naphthalene sulfonate derivatives, cellulosic derivatives, natural polysaccharides, silicone-based emulsions . . . .

The biostimulant composition according to the invention may, in another embodiment, also contain cells, provided that these cells do not correspond to the particular strain or strains that produced the supernatant. The cells added to the preparation may have specific properties to enhance the biostimulant effect of the supernatant preparation or additional properties, including antifungal properties. Thus, such cells can be chosen from a strain of Bacillus sp. distinct from the one used to produce the supernatant, particularly among the Bacillus subtilis, Bacillus amyloliquefaciens, Bacillus licheniformis, Paenibacillus polymixa, Bacillus pumilus, Bacillus thuringiensis, Bacillus sphaericus, Bacillus coagulans, Bacillus mycoides, Bacillus firmus, Bacillus velenzensis, Bacillus methylotrophicus, Bacillus megaterium, Bacillus vallismortis strains. Such cells may also not be Bacillus type strains but Paenibacillus sp., Pseudomonas sp. (Pseudomonas cepacia, Pseudomonas fluorescens, Pseudomonas chioraphis, Pseudomonas syringae), Streptomyces sp. (Streptomyces griseoviridis, Streptomyces lydicus). Such cells can also be yeasts, mycorrhizal fungi or Trichoderma sp. or Pythium sp . . . .

A third subject of the invention relates to a method for obtaining a biostimulant preparation for plant growth comprising the steps of (i) culturing at least one strain of Bacillus sp., (ii) incubating in a culture medium suitable for the secretion of molecules into the supernatant and (iii) harvesting the supernatant. In this method, the supernatant or an extract of the supernatant can be used directly as a biostimulant. The incubation time and culture medium are chosen according to the strains to be cultured; the skilled person will be able to adapt these parameters.

In a particular embodiment, the Bacillus strain(s) used in this method is/are preferably chosen from Bacillus sp. Bacillus subtilis, Bacillus amyloliquefaciens, Bacillus licheniformis, Paenibacillus polymixa, Bacillus pumilus, Bacillus thuringiensis, Bacillus coagulans, Bacillus mycoides, Bacillus sphaericus, Bacillus velenzensis, Bacillus firmus, Bacillus methylotrophicus, Bacillus megaterium, Bacillus vallismortis. Advantageously, Bacillus strains are chosen from Bacillus subtilis and Bacillus amyloliquefaciens strains. In a preferred embodiment, B. subtilis strains are selected from ATCC 6633, ATCC 21332, 168, ATCC 9943 and NCIB 3610 and their derivatives; B. amyloliquefaciens strains are selected from FZB42 and LMG S-29032 and their derivatives.

In addition, this method may include a step of concentrating the supernatant. The concentration of the preparation can be obtained by using one of the techniques well known to the skilled person. For example, the preparation can be concentrated either by membrane ultrafiltration, evaporation, physico-chemical precipitation or extraction.

Alternatively, this method may include a step of purification of lipopeptides. The purification step produces purified lipopeptides either to produce a solution containing no more than one type of lipopeptide or to produce a solution containing a combination of different lipopeptides. The purification of lipopeptides can be achieved by using one of the techniques well known to the skilled person. For example, the continuous sequence of ultrafiltration, diafiltration and final purification steps using organic solvents such as methanol, ethanol, butanol, ethyl acetate and chloroform, alone or in combination, can be mentioned. Alternatively, the purification of lipopeptides can be carried out by acid precipitation or by using mono or divalent cation salts (such as ammonium, magnesium, calcium, sodium salts, etc.). The biostimulant composition thus obtained can be dehydrated in the form of a powder to facilitate its conservation, storage and transport. Thus a biostimulant composition as defined above can be obtained by dissolving a supernatant powder to obtain the desired concentration in molecules of interest, in particular lipopeptides.

A fourth subject of the invention relates to a biostimulation method for promoting plant growth consisting in applying to one or all parts of the plant a biostimulating composition as defined above. In a preferred embodiment, the biostimulant composition is a composition comprising purified lipopeptides. In a particular embodiment, the biostimulant preparation may be applied by foliar treatment in order to obtain a significant gain in foliar and/or root and/or fruit and/or vegetable and/or cereal matter. This treatment can be applied, for example, by spraying the biostimulant composition.

In another particular embodiment, the biostimulant composition can be applied by root treatment in order to obtain a significant gain of foliar and/or root and/or fruit and/or vegetable and/or cereal material. This treatment can be applied, for example, by watering with the biostimulant preparation. In another embodiment, the biostimulant composition can be applied by seed treatment in order to obtain a significant gain in foliar and/or root and/or fruit and/or vegetable and/or cereal material. This treatment can be applied, for example, by coating with the biostimulant preparation.

Another subject of the invention relates to ornamental bulbs treated with a biostimulant composition as defined in this invention in order to obtain a significant gain in leaf material. Another subject of the invention relates to a seed coated with a biostimulant composition as defined in this invention. The coating of a vegetable seed is intended in particular to improve the initial growth of the plant.

### BRIEF DESCRIPTION OF THE DRAWINGS

FIG. 1: Descriptive table of molecular weights of the main lipopeptides produced by Bacillus sp.

FIG. 2: Measurement of the height of the tomato plants after application of concentrated compositions derived from Bacillus sp. Plant heights were measured after the application of compositions containing:(modality 1) composition derived from Bacillus amyloliquefaciens supernatant containing final concentrations for the treatment with 90 mg/L iturin A, 100 mg/L fengycin A and B and 60 mg/L surfactin A; (modality 2) Bacillus subtilis supernatant composition containing final concentrations for treatment with 175 mg/L mycosubtilin and 75 mg/L surfactin A; (modality 3) Bacillus subtilis supernatant composition containing final concentrations for treatment with 700 mg/L mycosubtilin and 300 mg/L surfactin A. The analysis revealed a significant effect of the treatment on plant height (P=0.0029). The statistical groups are indicated on the graph by the letters a and b.

FIG. 3: Measurement of the weight of fresh biomass of the aerial parts of tomato plants after application of concentrated compositions derived from Bacillus sp. culture supernatant. The weights of the fresh biomass of the aerial parts of tomato plants were measured after application of compositions containing:(modality 1) composition derived from Bacillus amyloliquefaciens supernatant containing final concentrations for the treatment of 90 mg/L iturin A, 100 mg/L fengycin A and B and 60 mg/L surfactin A; (modality 2) Bacillus subtilis supernatant composition containing final concentrations for treatment with 175 mg/L mycosubtilin and 75 mg/L surfactin A; (modality 3) Bacillus subtilis supernatant composition containing final concentrations for treatment with 700 mg/L mycosubtilin and 300 mg/L surfactin A. The analysis revealed a significant effect of the treatment on plant height (P=0.0029). The statistical groups are indicated on the graph by the letters a, b and c.

FIG. 4: Measurement of the increase in wet matter and roots of wheat plants after application of concentrated compositions derived from Bacillus sp. culture supernatant. The weights of the fresh biomass of the aerial and root parts of the wheat plants were measured after application only by root (R) or by root and foliar (R+F) application of compositions containing: (modality 1) composition derived from Bacillus amyloliquefaciens supernatant containing final concentrations for the treatment with 90 mg/L iturin A, 100 mg/L fengycin A and B and 60 mg/L surfactin A; (modality 2) Bacillus subtilis supernatant composition containing final concentrations for treatment with 175 mg/L mycosubtilin and 75 mg/L surfactin A; (modality 4) Bacillus subtilis supernatant composition containing final concentrations for treatment with 350 mg/L mycosubtilin and 150 mg/L surfactin A. The statistical groups are indicated on the graph by the letters A and B for the biostimulant effect on the aerial parts of the wheat plants and by the letters a and b for the biostimulant effect on the root parts of the wheat plants.

FIG. 5: Measurement of the increase in the chlorophyll content of the wheat plants after application of concentrated compositions derived from Bacillus sp. The chlorophyll content of the aerial parts of the wheat plants was measured after application only by root (R) or root and foliar (R+F) application of compositions containing:(modality 1) composition from Bacillus amyloliquefaciens supernatant containing final concentrations for the treatment with 90 mg/L iturine A, 100 mg/L fengycin A and B and 60 mg/L surfactin A of; (modality 4) composition from Bacillus subtilis supernatant containing final concentrations for the treatment with 350 mg/L mycosubtilin and 150 mg/L surfactin A. The statistical groups are indicated on the graph by the letters a, b and c.

FIG. 6: Measurement of the root length of the tomato seeds after soaking/coating treatment with compositions containing purified lipopeptides. The root length of the tomato seeds was measured after the application of compositions containing: (modality 1) Concentrated and purified supernatant of Bacillus subtilis culture containing 99% mycosubtilin; (modality 2) concentrated and purified supernatant of Bacillus subtilis culture containing 99% surfactin; (modality 3) concentrated and purified supernatant of Bacillus subtilis culture containing 99% fengycin; (modality 4) concentrated and purified supernatant of Bacillus subtilis culture supernatant containing 79% of a mixture of mycosubtilin and surfactin; Each modality is compared to a Control condition which corresponds to a control treated with the same volume of a 0.1% DMSO solution. The statistical groups are indicated on the graph by the letters a, b.

FIG. 7: Measurement of the growth gain of the tomato plants treated with compositions containing purified lipopeptides between the beginning and the end of the water stress period. The size of the tomato plants was measured at the end of the water stress period and compared to the size at the beginning of the period in order to estimate the gain after application of compositions containing: (modality 1) Supernatant of Bacillus subtilis culture concentrated and purified to a purity of 30% (lipopeptide mass/total dry mass) and the relative proportions of which are 80% mycosubtilin and 20% surfactin. This composition is applied at a rate of 75 g/ha of lipopeptides; (modality 2) Supernatant of Bacillus subtilis culture concentrated and purified to a purity of 30% (lipopeptide mass/total dry mass) and the relative proportions of which are 80% mycosubtilin and 20% surfactin. This composition is applied at a rate of 150 g/ha of lipopeptides; (modality 3) Supernatant of Bacillus subtilis culture concentrated and purified to a purity of 99% (lipopeptide mass/total dry mass) and the relative proportions of which are 80% mycosubtilin and 20% surfactin. This composition is applied at a rate of 150 g/ha of lipopeptides; each modality is compared to a Control condition which corresponds to a control treated with the same volume of a distilled water solution. The statistical groups are indicated on the graph by the letters a, b and c.

FIG. 8: Measurement of the photosynthetic efficiency of the tomato plants treated with compositions containing purified lipopeptides between the beginning and the end of the water stress period. Photosynthetic efficiency was measured by PAM fluorimetry at the beginning and the end of water stress and after application of compositions containing: (modality 1) Supernatant of Bacillus subtilis culture concentrated and purified to a purity of 30% (lipopeptide mass/total dry mass) and the relative proportions of which are 80% mycosubtilin and 20% surfactin. This composition is applied at a rate of 75 g/ha of lipopeptides; (modality 2) Supernatant of Bacillus subtilis culture concentrated and purified to a purity of 30% (lipopeptide mass/total dry mass) and the relative proportions of which are 80% mycosubtilin and 20% surfactin. This composition is applied at a rate of 150 g/ha of lipopeptides; (modality 3) Supernatant of Bacillus subtilis culture concentrated and purified to a purity of 99% (lipopeptide mass/total dry mass) and the relative proportions of which are 80% mycosubtilin and 20% surfactin. This composition is applied at a rate of 150 g/ha of lipopeptides; each modality is compared to a Control condition which corresponds to a control treated with the same volume of a distilled water solution. Graph A corresponds to the measurement at the beginning of water stress and graph B corresponds to the measurement at the end of water stress. The statistical groups are indicated on the graph by the letters a, b and c.

FIG. 9: Measurement of the stomatal conductance of the tomato plants treated with compositions containing purified lipopeptides between the beginning and the end of the water stress period. The stomatal conductance was analyzed with a porometer to measure the flow rate of carbon dioxide (CO) or water vapour through the stomata of a leaf at the beginning and the end of water stress and after applying compositions containing: (modality 1) Supernatant of Bacillus subtilis culture concentrated and purified to a purity of 30% (lipopeptide mass/total dry mass) and the relative proportions of which are 80% mycosubtilin and 20% surfactin. This composition is applied at a rate of 75 g/ha of lipopeptides; (modality 2) Supernatant of Bacillus subtilis culture concentrated and purified to a purity of 30% (lipopeptide mass/total dry mass) and the relative proportions of which are 80% mycosubtilin and 20% surfactin. This composition is applied at a rate of 150 g/ha of lipopeptides; (modality 3) Supernatant of Bacillus subtilis culture concentrated and purified to a purity of 99% (lipopeptide mass/total dry mass) and the relative proportions of which are 80% mycosubtilin and 20% surfactin. This composition is applied at a rate of 150 g/ha of lipopeptides; each modality is compared to a Control condition which corresponds to a control treated with the same volume of a distilled water solution. Graph A corresponds to the measurement at the beginning of water stress and graph B corresponds to the measurement at the end of water stress. The statistical groups are indicated on the graph by the letters a and b.

### DETAILED DESCRIPTION AND EXAMPLES

### Example 1: Preparation of a Biostimulant Composition

1.a Preparation of a Culture Supernatant

The culture supernatant is obtained from an aerobic fermentation process of a Bacillus strain derived from Bacillus subtilis ATCC 6633 strain or Bacillus amyloliquefaciens LMG S-29032 strain. The culture is carried out in a stirred medium containing a carbon source (glucose, sucrose, . . . ), a nitrogen source (ammonia sulphate, peptone . . . ) and trace elements at 30° C. The pH is maintained at a value of 7. The culture is harvested after 48 to 72 hours. It is then centrifuged or filtered to remove the cells. The culture supernatant is ready to be concentrated. The percentage of lipopeptides at this stage is in the range of 0.05 to 0.5% (weight/volume).

1.b Preparation of a Concentrated Biostimulant Preparation

By Tangential Filtration

The culture supernatant obtained via, for example, the preparation presented in 1.a is concentrated via tangential ultrafiltration using a membrane, the cut-off threshold of which can be from 1 KDa to 100 KDa. For example, 1000 L of culture supernatant obtained as described above are concentrated by passing over the membrane to obtain a retentate of a volume of 10 to 100 L.

By Precipitation at Acid pH

A second example of the preparation of a concentrated biostimulant preparation is a decrease in pH in order to precipitate lipopeptides. Concentrated sulphuric acid is added to the supernatant obtained, for example, via the preparation presented in 1.a. After obtaining a final pH around 1, the solution is left to be stirred for 2 to 12 hours. A centrifugation allows to recover a cull of material containing the lipopeptides. This cull is then dissolved by adding water and soda to obtain a pH value between 7 and 8.5. For example, when the cull is obtained from 1000 L of culture supernatant, this cull can be used in a total volume of 10 to 100 L.

The percentage of lipopeptides at the end of one of these two examples of preparation is between 1 and 15% (weight/volume).

### Example 2: Biostimulant Effect of the Composition Obtained from the Bacillus Culture Supernatant on Plant Growth

2.a Analysis of the Compounds Present in the Supernatant

The ability of the composition to be used as a biostimulant composition can be verified using analytical methods. The presence of lipopeptides, primary metabolites or enzymes from Bacillus culture in the composition can indeed be measured by different methods known to the skilled person, in particular by liquid chromatography coupled with mass spectrometry (or LC-MS), high performance liquid chromatography (HPLC) or colorimetric methods.

2.b Method for Evaluating the Biostimulant Effect on Plants The biostimulant effect of the composition can be assessed directly on the

plant by analyzing growth parameters. To this end, the culture supernatant or the composition derived therefrom can be applied to the upper parts of the plant, at the root level by watering, or by soaking the seeds. These modes of application can also be combined. The biostimulant effect is evaluated after a growth phase.

The biostimulant effect is obtained if at least one of the following criteria is met:
Increase in plant size (in height or thickness)
Increase in fresh and/or dry biomass of plant fruits
Increase in fresh and/or dry biomass of the aerial parts of the plant
Increase in fresh and/or dry biomass of the plant roots
Increase in the number of nodes, the number of spikes for cereal crops
Increase in the length of the plant root system
Increase in cereal, vegetable and/or fruit yield
Increase in chlorophyll content
Increased resistance to abiotic stress: for example, during water stress: increased photosynthetic efficiency, stomatal conductance, etc.

2.c Effect of Compositions Containing Lipopeptides on the increase in the Height of Tomato Plants.

Equipment and Methods

The test is carried out in a cultivation greenhouse to ensure semi-controlled conditions of temperature and sunshine:
Temperature: 25° C. by day/20° C. by night
Photoperiod: 14 hours of daylight/10 hours of night

The greenhouse is regulated for a minimum brightness of 175 W/m². Below this brightness, the lighting switches on and compensates for the brightness value. The shade extends beyond a brightness of 500 W/m² and folds down to 450 W/m².

Each modality is evaluated on 5 tomato plants previously transplanted at the 2-leaf stage in sandy agricultural soil. An initial fertilization is carried out two days before transplanting with a solution of red Hakaphos 8-12-24 provided at a rate of 0.2 g per tomato plant. The mode of use tested in this biostimulant efficiency test corresponds to a contribution of the product at the foot of the plants to tomato transplanting and after 3 weeks of foliar culture, considering a spray volume of 200 L/ha.

The tested compositions are as follows:
Supernatant of Bacillus amyloliquefaciens culture concentrated by a factor of 20 and diluted by a factor of 40 to obtain a concentration of 50 g/ha in lipopeptides the relative proportions of which are 36% for the Iturins family (here iturin A) and 24% for the surfactins family (here surfactin A) and 40% for the fengycins family (here fengycin A and B) (modality 1),
Supernatant of Bacillus subtilis culture concentrated by a factor of 20 and diluted by a factor of 40 to obtain a concentration of 50 g/ha in lipopeptides the relative proportions of which are 70% for the Iturin family (here mycosubtilin) and 30% for the surfactin family (here surfactin A) (modality 2),
Supernatant of Bacillus subtilis culture concentrated by a factor of 20 and diluted by a factor of 10 to obtain a concentration of 200 g/ha in lipopeptides the relative proportions of which are 70% for the Iturin family (here mycosubtilin) and 30% for the surfactin family (here surfactin A) (modality 3),
Control treated with the same volume of distilled water (Control modality).

The height of the plants and the fresh biomass of the aerial parts are then measured after 6 weeks of cultivation. The data are processed by an analysis of variance (ANOVA, LSD method at the 95% confidence level, i.e. a risk threshold of 5%) in order to highlight significant effects. The test is performed using STATGRAPHICS Centurion XV version 15.2.06 software.

Results

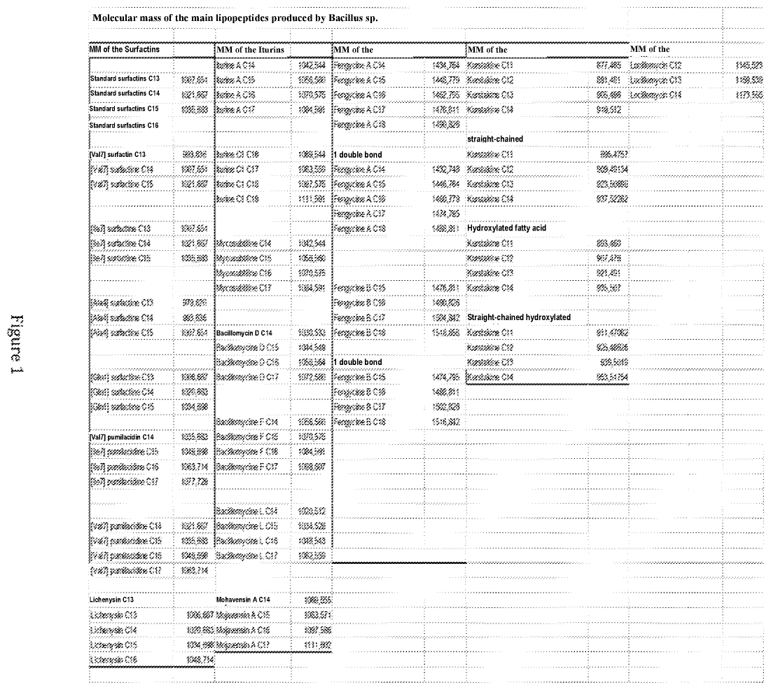

The experimental protocol makes it possible to compare the biostimulant effect of different compositions derived from a supernatant of a Bacillus strain culture on the height achieved by the tomato plants. The results are shown in FIG. 1. The statistical analysis shows a significant effect of the treatment on this parameter (P=0.0029). The statistical groups are indicated on the graph by letters a and b, all modalities have a significant biostimulant effect compared to the control.

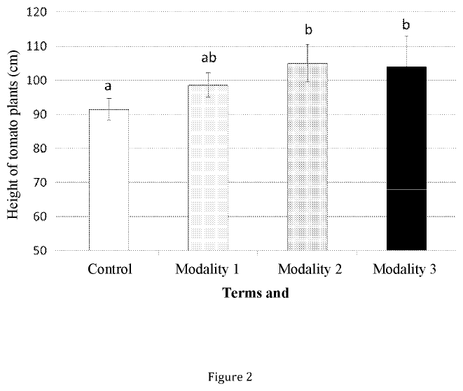

The results presented in FIG. 2 show that the compositions from Bacillus subtilis supernatant containing final concentrations for the treatment with 175 mg/L mycosubtilin and 75 mg/L surfactin A (modality 2) and final concentrations for the treatment with 700 mg/L mycosubtilin and 300 mg/L surfactin.

A of (modality 3) significantly increase the size of the tomato plants over a period of 6 weeks as compared to the untreated mode (Control modality). The biostimulant effect of the modality 1 from Bacillus amyloliquefaciens supernatant containing final concentrations for the treatment with 90 mg/L iturin A, 100 mg/L fengycin A and B and 60 mg/L surfactin A is much greater than the untreated control but belongs to the 2 statistical groups including that of the control.

2.d Effect of Lipopeptide Compositions on the increase in Fresh Biomass of the Aerial Parts of the Tomato Plants.

Equipment and Methods

The experimental protocol is identical to the one described in paragraph 2.c above.

Results

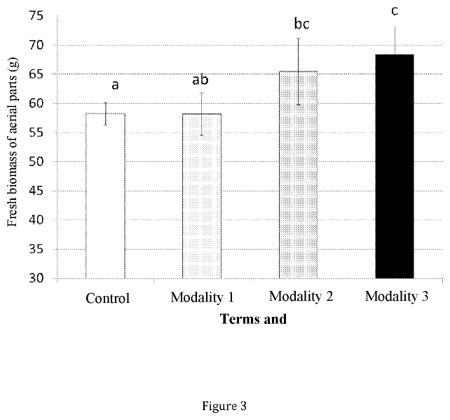

The experimental protocol makes it possible to compare the biostimulant effect of different compositions derived from a culture supernatant of a Bacillus strain on the weight of the fresh biomass of the aerial parts of the tomato plants. The results are shown in FIG. 3. The statistical analysis shows a significant effect of the treatment on this parameter (P=0.0029).

The statistical groups are indicated on the graph by the letters a, b and c. The results presented in FIG. 2 show that the compositions from Bacillus subtilis supernatant containing final concentrations for the treatment with 175 mg/L mycosubtilin and 75 mg/L surfactin A (modality 2) and final concentrations for the treatment with 700 mg/L mycosubtilin and 300 mg/L surfactin A (modality 3) allow a significant increase in the fresh biomass of the aerial parts compared to the untreated modality (Control mode). The biostimulant effect of modality 1 from Bacillus amyloliquefaciens supernatant containing final concentrations for the treatment with 90 mg/L iturin A, 100 mg/L fengycin A and B and 60 mg/L surfactin A is much greater than the untreated control but belongs to 2 statistical groups including the control.

2.e Effect of Lipopeptide Compositions on the Increase in the Production of Wet Material from Wheat Plants and Wet Material from Wheat Plant Roots

Equipment and Methods

The wheat seeds of the Tybalt variety were sown on an inert substrate. The roots developed in a liquid medium. When the wheat plants were in the 1-2 leaf stage, the plants were planted in pots with sandy clay soil. The pots were kept in a cultivation chamber with 16 hours of light and a temperature of 19° C.

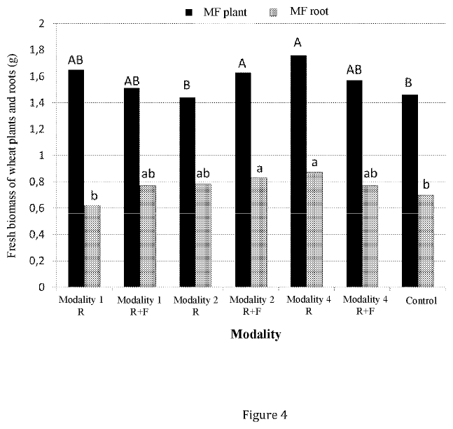

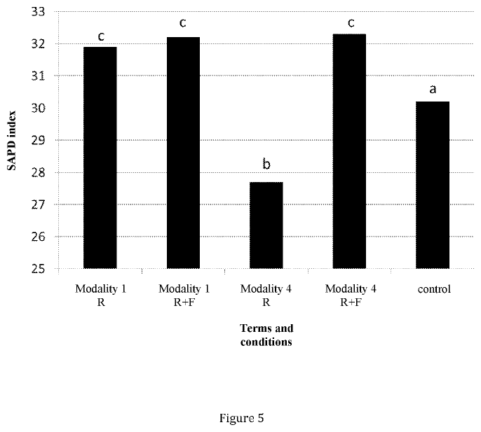

For each crop and treatment, 20 plants were grown. Ten plants were treated by root application (noted as R in FIGS. 4 and 5); 10 plants were not treated. Then, in the group of 10 plants treated by root application, 5 plants were then treated by foliar application (noted R+F in FIGS. 4 and 5); 5 plants were not treated (noted R in FIGS. 4 and 5).

The roots of wheat plants were treated by immersion in the various product solutions and immediately after the treatment planted in the pots with sandy fruit potting soil. Foliar applications were applied 4 weeks after planting, with a spray volume of 200 l/ha. The final measurement is made after 9 weeks of growth.

The data obtained were statistically analyzed with SAS 7. Normality was tested with Kolmogorov-Smirnov and equality of variances was tested by Levene's test. The normally distributed homoscedastic variables were subjected to a bidirectional one-way Anova with Tukey as a post hoc test.

The tested compositions are as follows:

Supernatant of Bacillus amyloliquefaciens culture concentrated by a factor of 20 and diluted by a factor of 40 to obtain a concentration of 50 g/ha in lipopeptides the relative proportions of which are 36% for the Iturins family (here iturin A) and 24% for the surfactins family (here surfactin A) and 40% for the fengycins family (here fengycin A and B) (modality I),
Supernatant of Bacillus subtilis culture concentrated by a factor of 20 and diluted by a factor of 40 to obtain a concentration of 50 g/ha in lipopeptides the relative proportions of which are 70% for the Iturin family (here mycosubtilin) and 30% for the surfactin family (here surfactin A) (modality 2),
Supernatant of Bacillus subtilis culture concentrated by a factor of 20 and diluted by a factor of 20 to obtain a concentration of 100 g/ha in lipopeptides the relative proportions of which are 70% for the Iturin family (here mycosubtilin) and 30% for the surfactin family (here surfactin A) (modality 4),
Control is treated with the same volume of distilled water (Control modality)

Results

The experimental protocol makes it possible to compare the biostimulant effect of different compositions derived from a supernatant of Bacillus strain culture on the weight of the fresh biomass of the aerial parts (MF plant) and the fresh root biomass (MF root) of the wheat plants. The results are shown in FIG. 4. The statistical groups are indicated on the graph by the letters A and B for the aerial parts and a and b for the roots.

Effect on the Fresh Biomass of the Aerial Parts of Wheat Plants

The results presented in FIG. 4 show that the compositions from Bacillus subtilis supernatant containing final concentrations for treatment with 175 mg/L mycosubtilin and 75 mg/L surfactin A (modality 2) applied by root and foliar applications (R+F) and final concentrations for the treatment with 350 mg/L mycosubtilin and 150 mg/L surfactin A (modality 4) applied by root application (R) allow a significant increase in the fresh biomass of the aerial parts compared to that of the untreated modality (Control modality).

The results presented in FIG. 4 show that the composition from a Bacillus amyloliquefaciens supernatant containing final concentrations for the treatment with 90 mg/L iturin A, 100 mg/L fengycin A and B and 60 mg/L surfactin A (modality 1) applied only by root (R) or root and foliar (R+F) application is much higher than the untreated control but belongs to 2 statistical groups including that of the control. A similar result is observed for modality 4 applied by root and foliar (R+F) application.

Effect on the Fresh Biomass of the Root Parts of Wheat Plants

The results presented in FIG. 4 show that the compositions from Bacillus subtilis supernatant containing final concentrations for the treatment with 175 mg/L mycosubtilin and 75 mg/L surfactin A (modality 2) applied by root and foliar (R+F) application and final concentrations for the treatment with 350 mg/L mycosubtilin and 150 mg/L surfactin A (modality 4) applied by root (R) application allow a significant increase in the fresh biomass of the root parts compared to those of the untreated modality (Control modality).

The results presented in FIG. 4 show that the composition from Bacillus amyloliquefaciens supernatant containing final concentrations for the treatment with 90 mg/L iturin A, 100 mg/L fengycin A and B and 60 mg/L surfactin A (modality 1) applied at the root and foliar level (R+F) is much higher than the untreated control but belongs to 2 statistical groups including that of the control. A similar result is observed for modality 2 applied by root (R) application and modality 4 applied by root and foliar (R+F) application.

2.f Effect of Lipopeptide Compositions on the Increase in Chlorophyll Content in Wheat Plants

Equipment and Methods

The experimental protocol is identical to the one described in paragraph 2.e above.

Results

The experimental protocol makes it possible to compare the biostimulant effect of different lipopeptide compositions derived from a supernatant of Bacillus strain culture on the chlorophyll content of the aerial parts of the wheat plants. The results are shown in FIG. 5. The statistical groups are indicated on the graph by the letters a, b and c.

The results presented in FIG. 5 show that the composition of a Bacillus subtilis supernatant containing final concentrations for the treatment of 350 mg/L mycosubtilin and 150 mg/L surfactin A (modality 4) applied by root and foliar (R+F) application allows a significant increase in the chlorophyll content of the aerial parts as compared to the untreated mode (Control mode). These results also show that the composition from Bacillus amyloliquefaciens supernatant containing final concentrations for the treatment with 90 mg/L iturin A, 100 mg/L fengycin A and B and 60 mg/L surfactin A (modality 1) applied by root (R) or root and foliar (R+F) application allows a significant increase in the chlorophyll content of the aerial parts as compared to those of the untreated modality (Control mode).

Example 3: Effect of Different Lipopeptide Compositions on the Root Size of Tomato Seeds After Soaking/Coating the Seeds

Equipment and Methods

The test was conducted on tomato seeds of the MONEYMAKER brand. The tomato seeds were previously disinfected by immersion in a 75/25 v/v ethanol/water solution for 2 min, then 30 min in 5% bleach (sodium hypochlorite) plus tween (0.1%) and finally rinsing with water until the foam completely disappeared. The seeds were then soaked for one hour in lipopeptide solutions of different purities and concentrations.

The lipopeptide solutions were concentrated (see the methods in 1.b) and then purified by tangential filtration. The solutions were then diluted in 0.1% DMSO to obtain lipopeptide concentrations for modality 1 of 50 and 100 pM, for modality 2 of 5, 20 and 100 pM, for modality 3 of 5, 20 and 100 pM, for modality 4 of 5, 20 and 100 pM. The seeds were placed vertically in petri dishes and refrigerated for one night to standardize germination. Then, the boxes were placed in an oven at 22° C. with a 16-hour photoperiod. A 0.1% DMSO solution in distilled water is used as a control for the experiment. Each modality is repeated 5 times in a Petri dish.

The tested compositions are as follows:
Supernatant of concentrated and purified Bacillus subtilis culture containing 99% of mycosubtilin (modality 1),
Supernatant of Bacillus subtilis culture concentrated and purified containing 99% of surfactin (modality 2),
Supernatant of Bacillus subtilis culture concentrated and purified containing 99% of fengycin (modality 3),
A concentrated and purified Bacillus subtilis culture supernatant containing 79% of a mixture containing the relative proportions of 40% mycosubtilin and 60% surfactin (modality 4),
Control treated with the same volume of a 0.1% DMSO solution (Control)

Root length was measured after 7 days of incubation of the boxes. Normality was tested with the Kolmogorov-Smirnov test and equality of variances was tested with the Brown-Forsythe test or the Kruskal-Wallis test. The variables were then subjected to an Anova with a post-hoc Student-Newman-Keuls test with P=0.05 (95% confidence level or 5% risk threshold) to highlight significant effects. The test was performed using SigmaPlot 14.0 software. The statistical groups are indicated by letters a and b.

Results

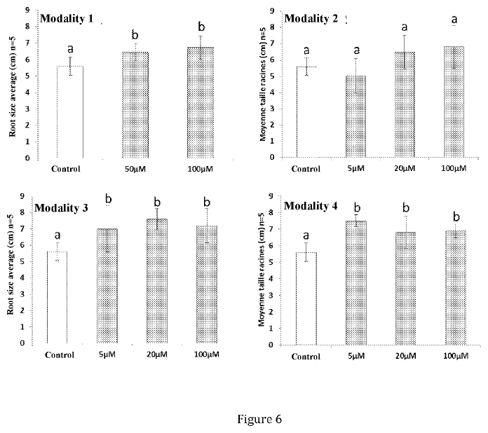

The experimental protocol makes it possible to compare the biostimulant effect of various purified lipopeptide compositions on the root length of the tomato seeds. The results presented in FIG. 6 show that the Bacillus subtilis supernatant compositions have a significant effect on the growth of tomato seeds roots, with the exception of modality 2. The statistical groups are indicated on the graph by the letters a and b. Based on these results, a significant effect of the treatment with modality 1 (mycosubtilin) on the root length can be observed from the 50 pM concentration (P=0.028). Although at concentrations of 20 pM and 100 pM an effect on the root length is observed with modality 2 (surfactin), it is not statistically different from the Control condition. A biostimulant effect on the root length is observed for modalities 3 (fengycin) (P=0.05) and 4 (mycosubtilin and surfactin mixture) from 5 pM (P=0.009).

### Example 4: Effect of Different Purified Lipopeptide Compositions on the Growth of Tomato Plants, Photosynthetic Efficiency and Stomatal Conductance under Water Stress Conditions

The objective of this test is to study the effect of lipopeptide compositions obtained from different concentrated and purified Bacillus subtilis supernatants on the growth, the photosynthetic efficiency and the stomatal conductance of tomatoes under water stress conditions. The compositions studied include different purities and different concentrations of lipopeptides.

Equipment and Methods

Plant Material

The test is conducted from tomato seeds of the FANDANGO Fi brand. The seeds are sown in patches of seedlings (Klasmann Peat). Moisture is kept close to saturation during germination (water is provided by sub-irrigation and spraying). At the 2-leaf spread stage (after 3 weeks), the plantlets are transplanted into the pots of soil for the test. During transplanting, the peat adhering to the roots is removed by soaking in water before repotting.

Preparation of the Soil and Cultivation Pots

The test soil is a sandy agricultural soil with a known composition. Before the test, it is screened to 10 mm, then the dry matter and water retention capacity are measured. At the start of the test, each pot contains 3.5 kg of raw soil watered at 70% of the maximum water retention capacity (CRmax) of the soil. The average weight of 5 pots is calculated in order to have a target weight corresponding to 70% of the CRmax.

The pots are watered at the set weight corresponding to 70% of the CRmax of water of the repotting soil during a period without water stress. In addition, an initial fertilizer supply of 100 mL of a 2 g/L solution of Hakaphos roude 8-12-24. 50 mL of this solution is also provided before water stress. During water stress, a solution of KNO3 and MgSO4 is added.

Water Stress

During the 3-week period of water stress, the pots are not watered for a week, then they are maintained for a week at 30% CRmax then for a week at 50% CRmax.

Duration of the Test

The test is placed in a cultivation greenhouse to ensure semi-controlled temperature and sunlight conditions:
temperature: 25° C. by day/20° C. by night
Photoperiod: 14 hours of daylight/10 hours of night

The greenhouse is regulated for a minimum brightness of 175 W/m². Below this brightness, the lighting switches on and compensates for the brightness value. The shade extends beyond a brightness of 500 W/m² and retracts below 450 W/m².

Tested Modalities

The different compositions are brought three times. For each contribution, 10 mL of the composition is provided per pot. The first contribution is made upon repotting, this contribution is a contribution to the soil. The other contributions are made by foliar spray. The second contribution is made after 3 weeks of cultivation and two days before the onset of water stress, the third is made after 10 days of water stress. The Control modality is treated with the same volume of distilled water.

The tested modalities are as follows and each modality includes 6 repeat pots. The tested compositions are as follows:
Control treated with the same volume of distilled water (Control)
Supernatant of concentrated Bacillus subtilis culture purified to a purity of 30% (lipopeptide mass/total dry mass) and the relative proportions of which are 80% mycosubtilin and 20% surfactin. This composition is applied at a rate of 75 g/ha of lipopeptides (modality 1),
Supernatant of concentrated Bacillus subtilis culture purified to a purity of 30% (lipopeptide mass/total dry mass) and the relative proportions of which are 80% mycosubtilin and 20% surfactin. This composition is applied at a rate of 150 g/ha of lipopeptides (modality 2),
Supernatant of concentrated Bacillus subtilis culture purified to a purity of 99% (lipopeptide mass/total dry mass) and the relative proportions of which are 80% mycosubtilin and 20% surfactin. This composition is applied at a rate of 150 g/ha of lipopeptides (modality 3),

The height gain of the plants between the beginning and the end of hydric stress, the photosynthetic efficiency at the beginning and the end of hydric stress and the stomatal conductance at the beginning and the end of hydric stress are measured and compared to the Control modality. The variables are then subjected to an Anova and a Kruskal-Wallis test with P=0.05 (95% confidence level or 5% risk threshold) to highlight significant effects. The test is performed using Statgraphics centurion XV software-Version 15.2.06. The statistical groups are indicated by the letters a, b and c.

Results

Height Gain of Tomato Plants between the Beginning and the End of Water Stress

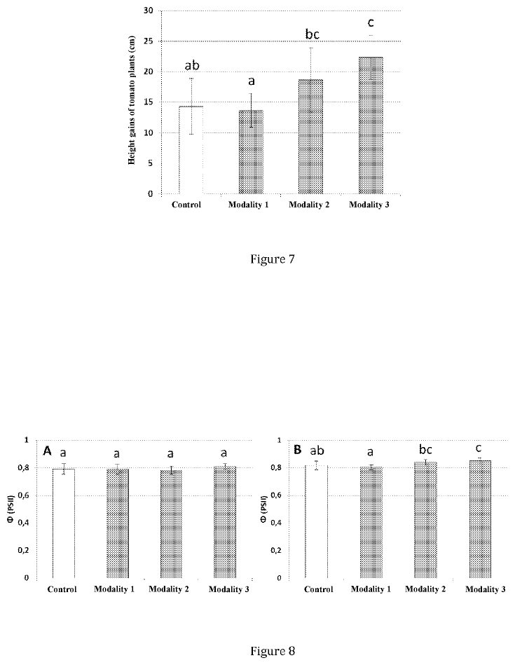

At the end of the water stress period the height of the tomato plants is compared to the initial height before the water stress period, the growth gain is shown in FIG. 7. Modality 1 is statistically no different from the control modality (P-value=0.432). A better growth is observed with modality 2 but this one is statistically no different from the control modality (P-value=0.124). A significantly different gain is observed with modality 3 compared to the control modality (P-value=0.008).

Photosynthetic Efficiency by PAM Fluorimetry

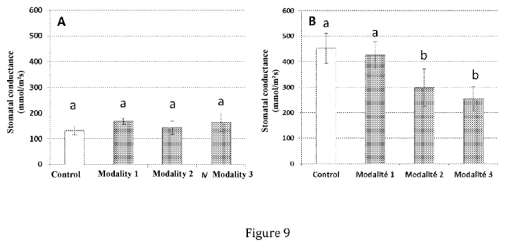

Photosynthetic efficiency was measured by PAM fluorimetry at the beginning and at the end of water stress. Under stress, the cp value (PSII) decreases and non-photochemical processes increase (heat dissipation and chlorophyll fluorescence) at the expense of photosynthesis. In FIG. 8A, a slight increase in cp (PSII) is observed for modality 3 but the effect is not statistically significant (P-value=0.4932). In FIG. 8B, an increase in cp (PSII) is observed for modalities 2 (statistically insignificant effect) and modality 3 (statistically significant effect) (P-value=0.0070), so these modalities are less stressed than the control condition. Modality 1 has a lower cp value (PSII) than the control condition (statistically insignificant effect).

Stomatal Conductance

The stomatal conductance measurement was performed with a porometer. This device is used to measure the stomatal conductance of the leaves. Stomatal conductance is the measurement of the flow rate of carbon dioxide (CO²) or water vapour through the stomata of a leaf. Stomata are small pores on the top and bottom of the leaf and are responsible for letting in and expelling CO and moisture from and to the outside air. The unit of measurement is millimoles per square meter second (mmol/m²s).

In FIG. 9 A at the beginning of water stress, modalities 1 and 3 have the highest stomatal conductance values, indicating a better opening of the stomata and therefore less stress of these modalities but this effect is not statistically significant (P-value=0.0544). In FIG. 9B at the end of water stress, modalities 2 and 3 have lower values than the Control modality and modality 1 (statistically significant effect, P-value=0.000). For these modalities 2 and 3, the stomata have closed, the plants retain water better and are more resistant to drought.

These tests make it possible to specify one of the mechanisms of action of lipopeptides contained in Bacillus subtilis concentrated supernatants as a biostimulant agent, namely to improve resistance to water stress. A dose effect is also observed, with significant effects obtained from 150 g/ha and above, regardless of the lipopeptide purity of said supernatant.

1. A use of at least one lipopeptide as a biostimulant for plant growth.

2. The use according to claim 1, wherein said biostimulant agent is a composition obtained from a supernatant of at least one strain of Bacillus sp, a concentrated lipopeptide composition or a composition comprising purified lipopeptides.

3. A biostimulant composition for plant growth, said composition comprising at least one lipopeptide as a biostimulant agent.

4. The composition according to claim 3, wherein said biostimulant agent is a composition obtained from a supernatant of at least one strain of Bacillus sp, a composition concentrated in lipopeptides or a composition comprising purified lipopeptides.

5. The composition according to claim 4, wherein said at least one strain of Bacillus sp. is/are is selected from the strains of Bacillus subtilis, Bacillus amyloliquefaciens, Bacillus licheniformis, Paenibacillus polymixa, Bacillus pumilus, Bacillus thuringiensis, Bacillus coagulans, Bacillus mycoides, Bacillus sphaericus, Bacillus velenzensis, Bacillus firmus, Bacillus methylotrophicus, Bacillus megaterium, Bacillus vallismortis.

6. The composition according to claim 5, wherein said at least one strain of Bacillus sp. is a strain of Bacillus subtilis, selected from: ATCC 6633, ATCC 21332, 168, ATCC 9943 and NCIB 3610 strains and the derivatives thereof or a strain of Bacillus amyloliquefaciens, selected from FZB42 and LMG S-29032 strains and the derivatives thereof.

7. The composition according to claim 3, wherein a concentration in said at least one lipopeptide is at least 20 mg/L (0.002%).

8. The composition according to claim 3, wherein said at least one lipopeptide is selected from molecules belonging to the iturin family and/or molecules belonging to the surfactin family and/or molecules belonging to the fengycin family and/or molecules belonging to the kurstakin family and/or molecules belonging to the locillomycin family.

9. The composition according to claim 3, further comprising between 0.002 and 25% of said at least one lipopeptide in the following proportions: molecules belonging to the 0-100% iturin familyand/or molecules belonging to the 0-100% surfactin familyand/or molecules belonging to the 0-100% fengycin family.

10. The composition according to claim 3, further comprising adjuvants.

11. The composition according to claim 3, further contains comprising cells other than supernatant-producing cells.

12. A method for obtaining a biostimulant composition for plant growth comprising the steps of:
cultivation of a strain of Bacillus sp.; and
harvesting supernatant including lipopeptides.

13. A method for obtaining a biostimulant composition for plant growth, wherein or at least one strain of Bacillus sp is selected from strains of Bacillus subtilis Bacillus, amyloliquefaciens, Bacillus licheniformis, Paenibacillus polymixa, Bacillus pumilus, Bacillus thuringiensis, Bacillus coagulans, Bacillus mycoides, Bacillus sphaericus, Bacillus velenzensis and Bacillus firmus, Bacillus methylotrophicus, Bacillus megaterium, Bacillus vallismortis, preferably among the strains of Bacillus subtilis or Bacillus am yloliquefaciens.

14. The biostimulation method for promoting plant growth according to claim 12, further comprising applying the composition including the lipopeptides by foliar treatment and/or root treatment and/or seed treatment and/or ornamental bulb treatment.

15. A seed coated with a biostimulant composition according to claim 3.
